(19) United States
(12) Patent Application Publication
(10) Pub. No.: US 2009/0149574 A1
(43) Pub. Date: Jun. 11, 2009

(54) Iron Filled Urethane Cementitious Flooring Composition

(75) Inventor: Rodrigo E. Sanchez, Atizapan (MX)

Correspondence Address: CURATOLO SIDOTI CO., LPA, 24500 CENTER RIDGE ROAD, SUITE 280, CLEVELAND, OH, 44145, US

(73) Assignee: Construction Research & Technology GmbH, Trostberg (DE)

(21) Appl. No.: 12/328,194

(22) Filed: Dec. 4, 2008

Related U.S. Application Data
(60) Provisional application No. 61/005,761, filed on Dec. 7, 2007.

(51) Int. Cl. C04B 24/28

(52) U.S. Cl. 524/2

(57) ABSTRACT

Cementitious flooring compositions are products obtained by mixing together and allowing to cure hydraulic cement, water, iron aggregate filler, and resin forming components comprising polyisocyanate and an isocyanate reactive compound. The compositions are particularly suitable for flooring applications and the mixtures, once made up, set very rapidly.

### CROSS REFERENCE TO RELATED APPLICATIONS

This application claims the benefit of the filing dale of U.S. Provisional Application for Patent Ser. No. 61/005.761 filed Dec. 7, 2007, incorporated by reference herein.

### TECHNICAL FIELD

Disclosed is a cementitious floor system having high durability for improved toughness and abrasion resistance to withstand high impact loads and to provide a high level of chemical resistance.

### BACKGROUND

Currently, there exists a variety of different floor systems and technologies, however very little is focused on high mechanical and chemical resistance. Among the most common technologies are: epoxy, urethane, urethane cementitious, methyl methacrylate (MMA) and cementitious.

Flooring systems must be able to withstand the heavy abuse they arc subjected to in industrial areas. Such abuse includes mechanical abuse, chemical attack, high impact of dropping materials or machinery, abrasion, vehicle traffic, and the like. Concrete or polymer coatings are often applied to the top of flooring systems in order to protect them from abuse. These coatings often fail after being subjected to various types of abuse over time. Frequently, these areas must be repaired within a short period of time.

For example, cementitious coatings have a low resistance to chemical attack and may fail if subjected to a high impact force. Cementitious coatings may also take up to 7 days to cure. This poses significant losses in industrial applications in the form of lost productivity. Not only must activity be stopped until a failed flooring system is removed and replaced, but in addition, activity will not be able to resume until the new door is cured. A cementitious system may offer high durability to impact and abrasion, but have a very weak chemical resistance since it depends on a limited cementitious matrix. Epoxies are basically used for medium duty applications and are the most common of all. MMA systems usually have higher mechanical resistance than epoxies but are still fragile systems that are not suitable for high impact conditions and are easily attacked by solvents.

Polymer floor coatings include the urethane and urethane cementitious systems. Inorganic and organic compositions comprising a foaming mixture of components including an organic polyisocyanate, a silica sol, and a water binding component such as hydraulic cement have been proposed for use as a foamed concrete in construction and civil engineering, including walls, flooring and insulation and have been considered for use as adhesives, mortars, or casting compositions, optionally filled with inorganic or organic fillers. Urethane can be used as a thin coating for light duty applications. Such urethane coatings may have low impact resistance, and may not able to withstand high impact forces. Urethane cementitious systems such as those disclosed in U.S. Pat. No. 4,211,680, incorporated herein by reference, do offer good mechanical and impact resistance and high chemical resistance, and their use is preferred over urethane coatings in industrial use. However, their impact resistance is less than cementitious flooring systems. With increasing demands upon the durability of flooring systems today, it is desirable to provide a flooring system having even higher durability to impact and abrasion than that which is offered by known urethane cementitious flooring systems, while at the same time providing higher chemical resistance than cementitious flooring systems.

### SUMMARY

Provided are unfoamed cementitious flooring compositions produced by forming a mixture of hydraulic cement, water, iron aggregate filler, and resin forming components comprising a polyisocyanate and an isocyanate-reactive organic compound, and allowing the mixture to cure.

### BRIEF DESCRIPTION OF THE DRAWINGS

FIG. 1 is a graphical representation of the toughness and impact resistance of the subject iron Filled urethane cementitious flooring composition tested in comparison to known flooring materials.

### DETAILED DESCRIPTION

The subject flooring composition relates to durable cementitious compositions suitable, for example, for the manufacture of industrial floors, and the like.

Fast setting cementitious compositions can be obtained by adding filler to polyisocyanate materials for urethane resins in conventional hydraulic cement/sand/water mixtures. One type of filler that may be used with urethane resin forming components in hydraulic cement/sand/water mixtures is iron aggregate filler. Another optional filler that may be used with urethane resin forming components in hydraulic cement/sand/water mixtures is silica. Silica may be added to the mixture in addition to iron aggregate in various amounts.

According to certain embodiments of the subject flooring composition, there are provided cementitious compositions which are the products obtained by mixing together and allowing to cure, hydraulic cement, water, filler, and resin forming components comprising a polyisocyanate and an isocyanate-reactive organic compound.

The term “hydraulic cement” is used in its usual sense to denote the class of structural materials which arc applied in mixture with water, and thereafter harden or set as a result of physical or chemical changes which consume the water present. In addition to Portland cement, hydraulic cement includes, among others:
1. Rapid hardening cements, such as those having high alumina contents.
2. Low-heat cements, characterized by high percentages of dicalcium silicate and tetracalcium alumino ferrite, and low percentages of tricalcium silicate and tricalcium aluminate.
3. Sulphate resisting cements, characterized by unusually high percentages of tricalcium silicate and dicalcium silicate, and unusually low percentages of tricalcium aluminate and tetracalcium alumino ferrite.
4. Portland blast-furnace cement comprising a mixture of Portland cement clinker and granulated slag,
5. Masonry cements, such as mixtures of Portland cement and one or more of the following: hydrated lime, granulated slag, pulverized limestone, colloidal clay, diatomaccous earth or other finely divided forms of silica, calcium stearate and paraffin.
6. Natural cements as characterized by material obtained from deposits in the Lehigh Valley, U.S.A.
7. Lime cements, comprising an oxide of calcium in its pure or impure forms, whether or not containing some argillaceous material.
8. Selenitic cement, characterized by the addition of 5-10% of plaster of Paris to lime.
9. Pozzolanic cement, comprising the mixture of pozzolan, Portland cement, calcium hydroxide, water, trass kieselguhr, pumice, tufa, santorin earth or granulated slag with lime mortar.
10. Calcium sulphate cements, characterized by depending on the hydration of calcium sulphate, and including plaster of Paris, Keene's cement and Parian cement.

Iron fillers may vary in particle size. In certain embodiments, iron fillers may be ground into a powder-like form. The fineness of iron particles may vary. In certain embodiments, their particle size may be within the range from those passing about 4 Tyler sieve size to about 50 Tyler sieve size, with their particle sizes being substantially within the range of those passing from about 30 Tyler sieve size to about 50 Tyler sieve size. The iron filler may be employed as aggregate in the composite flooring system.

Silica fillers which may be used include but arc not limited to silica sands and silicas having low clay content. Silica fillers typically have a particle size within the range of about 1.5 inches to about 200 British Standard sieve size, although sizes outside these limits may be used for different applications. The silica fillers may be washed, in some embodiments.

Polyisocyanates may be formed from resin-forming components. Polyisocyanates which may be used include but are not limited to toluene diisocyanate or diphenyl methane diisocyanate, uretedione or isocyanurate polymers thereof, and isocyanate-terminated polyurethanes obtained by reacting an excess of an organic diisocyanate with a polyfunctional isocyanate-reactive compound such as a glycol or higher polyhydric alcohol, an amino alcohol or polyamine, or a hydroxyl-terminated polyester, polyesterimide or polyether.

Illustrative but not limiting examples of an isocyanate-reactive organic compound for use in this composition include but are not limited to polyol, such as a dihydric or trihydric polyether having an equivalent weight from 100 to 1500, but polyhydric alcohols, aminoalcohols, polyesters and polyesteramides may also be used.

Polyols may include, for example, oxypropylated glycerol, oxypropylated triethanolamine, hydroxyl-terminated polymers obtained by reaction of a polyisocyanate such as toluene diisocyanate with excess of a hydroxyl-terminated polyester, polyesteramide or polyether, hydroxyl group-containing polyether resins obtained by reacting diphenylolpropane with epichlorohydrin, or alkyd resins, both drying and non-drying.

Solvents and thinners which are inert towards isocyanate groups may also be added. Examples of such inert solvents include but are not limited to esters, ketones, hydrocarbons and chlorinated hydrocarbons.

The proportions of the different ingredients used in the present compositions may vary widely. Thus, per 100 parts by weight of hydraulic cement there may be used from about 10 to about 10,000 parts by weight of filler, from about 10 to about 75 parts by-weight of water, from about 5 to about 5,000 parts by weight of resin-forming components comprising organic polyisocyanate and isocyanate-reactive organic compounds, and from 0 to about 200 parts by weight of solvent.

The present compositions, according to their fluidity, may be used as a self-leveling or trowelling flooring finishes. The subject flooring systems comprising such compositions are superior to ordinary cementitious floorings or other known resin-bonded cementitious flooring compositions because the subject flooring system has higher resistance to mechanical abuse than current flooring systems in the industry, while at the same time maintaining a high resistance to chemical abuse.

### Embodiments

The following examples are not intended to be exhaustive and should not be construed as limiting the flooring composition, the flooring system or method for producing the flooring system in any manner. All concentrations are defined by percent by weight and are based on the total weight of the components of the composition unless otherwise specifically stated. All particle sizes are expressed in terms of percent passing through a particular sized mesh unless otherwise specifically slated. All mesh sizes are defined by Tyler sieve size unless otherwise specifically stated.

By combining a ductile aggregate with a ductile and tough binder that can easily be filled with the aggregate, a more ductile floor system that can resist higher impact loads (i.e. truck brakes hitting the floor), chemical attack, and other abuse is obtained. In this embodiment, a ductile aggregate that may be employed is iron aggregate. Polyurethane based cementitious binders are desirable over cementitious binders in order to obtain a higher chemical resistance.

In one embodiment, the subject urethane cementitious flooring system provides a very high strength floor system having a ductile binder (polyurethane), but in addition to a fragile aggregate (silica sand) includes a ductile aggregate (iron) to provide a high impact strength. Polyurethane cementitious binder was combined with 15 kg of iron aggregate, resulting in a very heavy mix mortar similar to urethane cementitious flooring compositions but with greater impact resistance. The high viscosity resin mix present in the polyurethane prevented the iron particles from segregating to the bottom of the mixture. Saw cutting some samples indicated that iron aggregate did not segregate.

A two square meter test area of a flooring composition comprising iron aggregate within a polyurethane cementitious binder yielded impressive results over both epoxy and cementitious flooring materials filled with metallic aggregate, which lead to the successful testing of a 24 square meter lest area over an extended period of time.

### COMPARATIVE EXAMPLE 1

It has been found that fast setting cementitious compositions can be obtained by adding filler to resin forming components comprising polyisocyanate and isocyanate reactive organic compounds in conventional hydraulic cement/sand/water mixes. The example below provides a flooring system that utilizes a silica filler. This flooring system possessed high chemical resistance and has good mechanical and impact resistance (See Table 1 below).

Polyurethane Cementitious Flooring Composition

| | % |
|---|---|
| Compound | By Weight |
| Iron Aggregate | 0.00 |
| Silica | 68.68 |
| Calcium Magnesium Hydroxide | 2.19 |
| Cement | 8.76 |
| UCRETE ® Part A (Polyol - Isocyanate Reactive Compound) | 11.11 |
| UCRETE ® Part B (Isocyanate) | 9.26 |
| Total | 100 |

### EXAMPLE 2

A urethane cementitious flooring composition was prepared according to the example below, containing iron aggregate filler in addition to silica filler. This flooring system possessed high chemical resistance as well as high mechanical and impact resistance (See Table 1 below).

Polyurethane Iron Aggregate Cementitious Flooring Composition

| | % |
|---|---|
| Compound | By Weight |
| Iron Aggregate | 27.65 |
| Silica | 43.58 |
| Calcium Magnesium Hydroxide | 2.39 |
| Cement | 8.91 |
| UCRETE ® Part A (Polyol - Isocyanate Reactive Compound) | 9.52 |
| UCRETE ® Part B (Isocyanate) | 7.94 |
| Total | 100 |

A variety of compounds may be used as ingredients in the formation of the Isocyanate Reactive Compound Part A and the Isocyanate Part B, as set forth above. Both UCRETE® Part A and UCRETE® Part B that may be used in the formation of the polyurethane iron aggregate cementitious flooring composition, are available from BASF Building Systems, Shakopee, Minn. The listed examples arc not intended to be exhaustive and should not be construed as limiting the ingredients of Isocyanate Reactive Compound Part A and Isocyanate Part B in any way.

As shown in Table 1 below, by introducing iron aggregate in the urethane cementitious flooring system, the iron filled urethane cementitious flooring system demonstrates a higher mechanical and impact resistance, while preserving high chemical resistance that is not typical among iron filled cementitious systems. Adding iron aggregate to the composition may reduce the amount of silica sand needed for use as filler. For instance, in comparative example 1. the silica sand component of the composition was present in the amount of 68.68% by weight when no iron aggregate was used. In example 2, the amount of silica sand used decreased to 43.58% by weight when iron aggregate was added in the amount of 27.65% by weight. The addition of iron aggregate into the composition may also permit an increase in the amount of calcium magnesium hydroxide and cement used and decrease the amount of Isocyanate Reactive Compound Part A and Isocyanate Part B needed.

TABLE 1
Flooring Systems Physical Property Comparisons

| | | Urethane | | | Urethane |
|---|---|---|---|---|---|
| | | Cementitious | Iron Filled | Iron Filled | Cementitious |
| Property | Concrete | (Silica Filled) | Cementitious | Epoxy | Iron Filled |
| Compressive | | | | | |
| Strength | | | | | |
| 1 day | | | 5,040 psi | 5,600 psi | 4,335 psi |
| 3 days | | | | | 5,998 psi |
| 7 days | | 6,247 psi | 8,800 psi | 12,600 psi | 6,806 psi |
| 14 days | | | | | 7,332 psi |
| 28 days | 4,010 psi | | 12,050 psi | | 7,873 psi |
| Tensile Strength | | | | | |
| 1 day | | | | | 502 psi |
| 7 days | 240 psi | 800 psi | | | 792 psi |
| Flexural Strength | | | | | |
| 1 day | | | | | 1,237 psi |
| 7 days | 250 psi | 1.800 psi | | | 2.100 psi |
| Impact Resistance - | <160 in/lb | >160 in/lb | >240 in/lb | >240 in/lb | >240 in/lb |
| Gardner | | | | | |
| Toughness (LA | >40% | 15.80% | 18-20% | 12.70% | 5% |
| Device) | | | | | |
| Abrasion | 0.085 in | 0.063 in | 0.017 in | 0.015 in | 0.015 in. |
| Resistane779A | | | | | |
| Coefficient of | 5.5 × 10⁻⁶ in/in/° F. | 1.1 × 10⁻⁵ in/in/° F. | | | 1.2 × 10⁻⁵ in/in/° F. |
| Thermal | | | | | |
| Expansion | | | | | |
| Modulus of | 4.3 × 10⁶ psi | 1.7 × 10⁵ psi | 3.9 × 10⁶ psi | 2.8 × 10⁶ psi | 1.2 × 10⁶ psi |
| Elasticity | | | | | |
| Cure Time | | | | | |
| Foot Traffic | | | | 24 hours | |
| Vehicular Traffic | | | | 48 hours | 12-24 hours |
| Installation Time | 7 day wet cure | 12-24 hours | 7 day wet cure | 48-72 hours | 12-24 hours |
| Shore D Hardness | 65 | 80 | 85 | 85 | 90 |

In certain embodiments, the iron aggregate to be added to the flooring composition may be in powder form. The size of the iron aggregate particles may vary but may generally fall within the range of about 4 and about 50 Tyler sieve size. A substantial portion of the powdered iron aggregate particles may range between about 30 to about 50 Tyler sieve size as shown in Table 2 below.

TABLE 2
Iron Aggregate Partical Size Distribution

| Mesh Size (Tyler) | % Iron Aggregate Passing | |
|---|---|---|
| 4 | 100% | by weight |
| 8 | 95 to 100% | by weight |
| 16 | 88 to 100% | by weight |
| 30 | 18 to 32% | by weight |
| 50 | 0 to 5% | by weight |

The calcium magnesium hydroxide component of the flooring composition may be in powder-like form. Particle sizes of the calcium magnesium hydroxide may range from less than about 10% being retained on 30 to 325 Tyler sieve size as shown in Table 3 below.

TABLE 3
Calcium Magnesium Hydroxide Particle Size Distribution

| Mesh Size (Tyler) | % Calcium Magnesium Hydroxide Retained |
|---|---|
| 30 | 0% by weight |
| 200 | 5.5% by weight |
| 325 | 9.75% by weight |

Table 1 above makes some comparisons between the different types of flooring compositions. One advantage of iron filled urethane cementitious flooring compositions is that they exhibit a greater compressive strength than urethane cementitious flooring compositions. As shown in Table 1, iron filled urethane flooring compositions after 7 days of curing had a compressive strength of 6,806 psi, while the comparative urethane cementitious floor systems (silica filled) had a compressive strength of 6,247 psi, a difference of nearly 10% improvement for the subject flooring composition.

Tensile strength between iron filled urethane cementitious flooring compositions and urethane cementitious (silica filled) flooring compositions is comparable, being about 792 psi as compared to about 800 psi for urethane cementitious (silica filled) after 7 days of curing.

Another advantage of iron filled urethane cementitious flooring compositions is that they demonstrate a greater flexural strength than only silica filled urethane cementitious flooring systems. In this regard, Table 1 shows a flexural strength of about 2,100 psi for the iron filled urethane cementitious composition as compared to about 1,800 psi for the urethane cementitious composition.

Abrasion resistance of iron filled urethane cementitious flooring compositions is comparable to iron filled cementitious and iron filled epoxy flooring compositions being about 0.15 in. Abrasion resistance for urethane cementitious (silica filled) flooring compositions is much less, at about 0.063 in.

Iron filled urethane cementitious flooring compositions also demonstrate an improved impact resistance from that of iron filled cementitious flooring compositions. While not as great as iron filled epoxy flooring compositions, iron filled urethane cementitious flooring compositions exhibited an impact resistance of greater than 240 in/lb.

### Impact/Toughness Testing

Heavy industrial traffic involves more than just abrasion. Impact from a variety of sources puts a heavy strain on industrial floors. The ability of a floor to withstand the strain and impact determines the life of the floor. The straining capacity of a material is the main contributor to its toughness and the toughness of a material is mainly responsible for its impact resistance.

The impact resistance of the flooring materials set out in Table 1 were tested through the use of an Los Angeles Machine (ASTM C535). This lest machine, also known as the LA Rattler, consists of a rotating steel drum containing 18 steel spheres (1-¾″ diameter). As the drum rotates, a shelf picks up the flooring samples (2″×2″×2″ cubes) and the steel spheres, carrying them around until they are dropped to the opposite side of the drum: creating an impact-crushing effect. The contents then roll within the drum with an abrading and grinding action until the shelf plate impacts them and the cycle is repeated. After 2000 revolutions, the flooring specimens are removed from the drum and weighed in order to determine the amount of weight loss.

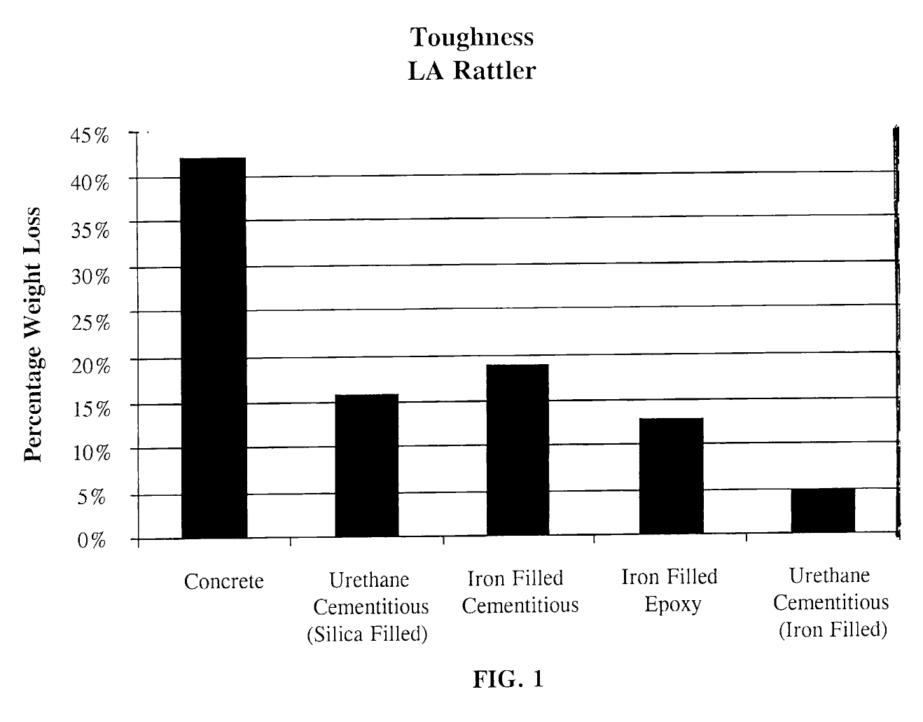

Results of the tests conducted on the five different types of flooring materials are shown in FIG. 1. The subject iron filled urethane cementitious flooring composition samples exhibited greater toughness than would have been expected or predicted, exhibiting the lowest percentage weight loss of any of the flooring types tested.

Iron filled urethane cementitious flooring compositions have a short cure lime of about 12 to about 24 hours for vehicular traffic. This is the same as the cure time for urethane cementitious flooring compositions. Iron filled cementitious flooring systems on the other hand, may take up to 7 days to cure, while the cure time for iron filled epoxy flooring compositions is about 48 hours for vehicular traffic.

Installation time for iron filled urethane cementitious flooring compositions is also short, being about 12 to about 24 hours. This is the same as the installation time for urethane cementitious flooring compositions, but is shorter than iron filled cementitious (7 day wet cure) and iron filled epoxy (about 48 to about 72 hours) flooring compositions.

While the flooring compositions have been described above in connection with certain illustrative embodiments, it is to be understood that other similar embodiments may be used or modifications and additions may be made to the described embodiments for performing the same function without deviating therefrom. Further, all embodiments disclosed are not necessarily in the alternative, as various embodiments may be combined or subtracted to provide the desired characteristics. Variations can be made by one having ordinary skill in the art without departing from the spirit and scope hereof. Therefore, the flooring composition should not be limited to any single embodiment, but rather construed in breadth and scope in accordance with the recitations of the attached claims.

I claim:

1. An unfoamed cementitious flooring composition produced by forming a mixture of hydraulic cement, water, iron aggregate filler, and resin forming components comprising a polyisocyanate and an isocyanate-reactive organic compound, and allowing the mixture to cure.

2. The unfoamed cementitious composition of claim 1 wherein the iron aggregate filler particle size is within the range from about 4 Tyler sieve size to about 50 Tyler sieve size.

3. The unfoamed cementitious composition of claim 1 wherein from about 95 to about 100% of the iron aggregate filler passes through a mesh having an 8 Tyler sieve size, from about 88 to about 100% of the iron aggregate filler passes through a mesh having a 16 Tyler sieve size, from about 18 to about 32% of the iron aggregate filler passes through a mesh having a 30 Tyler sieve size, and from about zero to about 5% of the iron aggregate filler passes through a mesh having a 50 Tyler sieve size.

4. The unfoamed cementitious flooring composition of claim 1 wherein the mixture additionally includes silica filler.

5. The unfoamed cementitious flooring composition of claim 4 wherein the silica filler has a particle size within the range of about 1.5 inches to about 200 British Standard sieve size.

6. The unfoamed cementitious flooring composition of claim 1 wherein the mixture additionally includes calcium magnesium hydroxide filler.

7. The unfoamed cementitious flooring composition of claim 6 wherein the calcium magnesium hydroxide filler particle size ranges from less than about 10% being retained on 30 to 325 Tyler sieve size.

8. The unfoamed cementitious flooring composition of claim 1 wherein said polyisocyanate comprises at least one of toluene diisocyanate, diphenyl methane diisocyanate, uretedione or isocyanurate polymers thereof, or isocyanate-terminated polyurethanes obtained by reacting an excess of an organic diisocyanate with a polyfunctional isocyanate-reactive compound such as a glycol or higher polyhydric alcohol, an amino alcohol or polyamine, or a hydroxyl-terminated polyester, polyesteramide or polyether.

9. The unfoamed cementitious flooring composition of claim 1 wherein said polyisocyanate is at least one of toluene diisocyanate and diphenyl methane diisocyanate.

10. The unfoamed cementitious flooring composition of claim 1 wherein said isocyanate-reactive organic compound comprises at least one of a polyol, a dihydric or trihydric polyether having an equivalent weight from about 100 to about 1500, a polyhydric alcohol, an aminoalcohol, a polyester or a polyesteramide.

11. The unfoamed cementitious flooring composition of claim 10 wherein the isocyanate-reactive compound is a polyol.

12. The unfoamed cementitious flooring composition of claim 11 wherein said polyol comprises at least one of oxypropylated glycerol, oxypropylated triethanolamine, or a hydroxyl-terminated polymer obtained by reaction of a polyisocyanate with excess of a hydroxyl-terminated polyester, polyesteramide, polyether, or hydroxyl group-containing polyether resins obtained by reacting diphenylolpropane with epichlorohydrin or alkyd resins.

13. The unfoamed cementitious flooring composition of claim 11 wherein the polyisocyanate is present in an amount sufficient to provide an excess of isocyanate groups over the hydroxyl groups of the polyol.

14. The unfoamed cementitious flooring composition of claim 1 further comprising at least one solvent or thinner which is inert towards isocyanate groups.

15. The unfoamed cementitious flooring composition of claim 4 comprising per 100 parts by weight of hydraulic cement, from about 10 to about 10,000 parts by weight of filer, from about 10 to about 75 parts by weight of water, from about 5 to about 5.000 parts by weight of resin-forming components comprising organic polyisocyanate and isocyanate-reactive organic compounds, and from 0 to about 200 parts by weight of solvent.

16. The unfoamed cementitious flooring composition of claim 1 wherein said mixture is capable of being used as a self-leveling flooring finish.

17. The unfoamed cementitious flooring composition of claim 1 wherein said mixture is capable of being used as a trowelling flooring finish.

18. The unfoamed cementitious flooring composition of claim 1 wherein said mixture is capable of solidifying at a rate to obtain a sufficiently cured floor from in about 12 to about 24 hours.

19. The unfoamed cementitious flooring composition of claim 1 which is capable of withstanding a falling weight of impact greater than about 240 in/lb after only from about 12 to about 24 hours of curing and which offers a high chemical resistance.
